(19) United States
(12) Patent Application Publication
(10) Pub. No.: US 2017/0298887 A1
(43) Pub. Date: Oct. 19, 2017

(54) SYSTEMS AND METHODS FOR CONTROLLING FUEL INJECTION INTO A PLURALITY OF FUEL RAILS

(71) Applicant: Cummins Inc., Columbus, IN (US)

(72) Inventors: Lester L. Peters, Columbus, IN (US); Bradlee J. Stroia, Columbus, IN (US); Anthony Shaull, Columbus, IN (US); Rodney J. Hemmerlein, Columbus, IN (US); Richard Davis Thomas, North Vernon, IN (US)

(21) Appl. No.: 15/097,818

(22) Filed: Apr. 13, 2016

(51) Int. Cl. F02M 63/00; F02M 55/02

(52) U.S. Cl. CPC F02M 63/0007; F02M 55/025

(57) ABSTRACT

Fueling systems and methods are disclosed. Various fueling systems may comprise a single fuel pump configured to supply fuel to a first fuel rail at a first fuel pressure along a first fuel circuit and configured to supply fuel to a second fuel rail at a second fuel pressure along a second fuel circuit, wherein the first fuel rail and second fuel rail are arranged in parallel, and the first fuel circuit is independent of the second fuel circuit.

### FIELD OF THE DISCLOSURE

This disclosure relates to pumps, such as fuel pumps that feed a plurality of independently controlled fuel rails. More specifically, this disclosure relates to pumps that feed a plurality of independently controlled fuel rails using active inlet metering.

### BACKGROUND

Conventional engines, such as those found in vehicles or generators, will typically include a fuel pump to supply fuel to a fuel rail that in turn supplies fuel to the fuel injector. The fuel injector then supplies the fuel to the combustion chamber where the chemical energy is converted into mechanical energy with the use of pistons.

Actively monitoring the pressure and volume of fuel in the fuel rail is important to help improve efficiency of the engine and is also an important factor in limiting the amount of pollution produced by the engine. For example, by reducing the rate of fuel flow during the initial portion of an injection event, the amount of NOₓ can be significantly reduced.

However, conventional systems having a reduced rate of fuel flow during the initial portion of the injection event may require higher flow rates or pressures during later portions of the injection events. Therefore, some conventional engines—such as diesel engines—may include multiple injectors during an entire injection event. These systems may often use a plurality of fuel rails supplying differing pressures and flow rates of fuels to different injectors.

Conventional systems however, typically require either multiple fuel pumps to separately supply each fuel rail or may combine fuel circuit paths. Multiple fuel pumps may increase the costs, complexity, and maintenance of such systems and may also decrease the robustness of such systems. The conventional combining of fuel paths may reduce the flexibility of the fueling systems to respond to the needs of the engine (e.g., due to the interdependence of the shared portion of the fuel circuit), such as fixing the relative pressures of two separate rails (i.e., the higher pressure rail may be fixed in that it cannot be changed by a controller (e.g., an electronic control module (ECM)) to become the lower pressure rail), which may limit the effectiveness of such systems.

A need therefore exists to address issues of supplying more than one fuel rail operated at separate pressures with a single fuel pump.

### SUMMARY

In some embodiments, fueling systems may comprise a fuel pump operationally coupled to a first inlet valve, a second inlet valve, a first outlet valve, and a second outlet valve; and a controller in electrical communication with the first inlet valve, the second inlet, a first fuel rail operationally coupled to the first inlet valve, and a second fuel rail operationally coupled to the second inlet valve; wherein the controller is configured to receive a first pressure reading indicating a fuel pressure in the first fuel rail and a second pressure reading indicating a fuel pressure in the second fuel rail, and the controller is configured to adjust the first inlet valve in response to the first pressure reading to supply a first fuel rail pressure to the first fuel rail and to adjust the second inlet valve in response to the second pressure reading to supply a second fuel rail pressure to the second fuel rail, the first fuel rail pressure being different than the second fuel rail pressure.

In some embodiments, fueling systems may comprise a single fuel pump configured to supply fuel at a first pressure to a first fuel rail along a first fuel circuit and configured to supply fuel at a second pressure to a second fuel rail along a second fuel circuit, wherein the first fuel rail and second fuel rail are arranged in parallel, and the first fuel circuit is independent of the second fuel circuit.

In various embodiments, methods of supplying fuel to an engine may comprise supplying fuel to a first fuel rail from a first output valve operationally coupled to a fuel pump operationally coupled to a first inlet valve, supplying fuel to a second fuel rail from a second output valve of the fuel pump operationally coupled to a second inlet valve, supplying fuel to a first injector operationally coupled to the first fuel rail, and supplying fuel to a second injector operationally coupled to the second fuel rail, wherein a first fuel rail pressure is different than a second fuel rail pressure.

### BRIEF DESCRIPTION OF THE DRAWINGS

The above mentioned and other features and objects of this disclosure, and the manner of attaining them, will become more apparent and the disclosure itself will be better understood by reference to the following description of exemplary embodiments of the disclosure taken in conjunction with the accompanying drawings, wherein:

FIG. 1 is a diagram of a fueling system according to various embodiments;

FIG. 2A is a perspective view of a fuel pump configured to supply two separate rails operationally configured to operate at two separate pressures;

FIG. 2B is a partial cross-sectional view of an exemplary fuel pump;

FIG. 2C is a top perspective view of a fuel pump;

FIG. 2D is a frontal perspective view of a fuel pump; and

FIG. 3 is a flow diagram of a method of supplying fuel to an engine according to various embodiments.

Corresponding reference characters indicate corresponding parts throughout the several views. Although the drawings represent embodiments of the present disclosure, the drawings are not necessarily to scale and certain features may be exaggerated in order to better illustrate and explain the present disclosure. The exemplification set out herein illustrates exemplary embodiments of the disclosure, in various forms, and such exemplifications are not to be construed as limiting the scope of the disclosure in any manner.

### DETAILED DESCRIPTION

The embodiment disclosed below is not intended to be exhaustive or limit the disclosure to the precise form disclosed in the following detailed description. Rather, the embodiments are chosen and described so that others skilled in the art may utilize its teachings.

One of ordinary skill in the art will realize that the embodiments provided can be implemented in hardware, software, firmware, and/or a combination thereof. For example, the controllers disclosed herein may form a portion of a processing subsystem including one or more computing devices having memory, processing, and communication hardware. The controllers may be a single device or a distributed device, and the functions of the controller may be performed by hardware and/or as computer instructions on a non-transient computer readable storage medium. For example, the computer instructions or programming code in the controller (e.g., an electronic control module (ECM)) may be implemented in any viable programming language such as C, C++, HTML, XTML, JAVA or any other viable high-level programming language, or a combination of a high-level programming language and a lower level programming language.

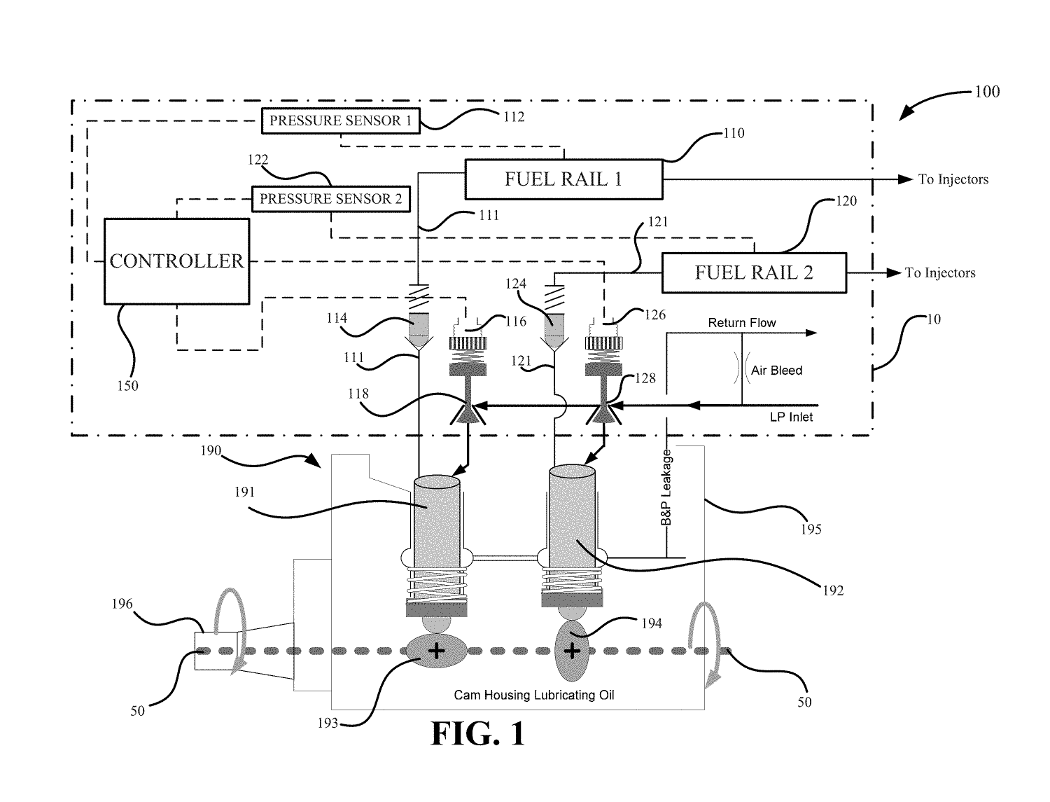

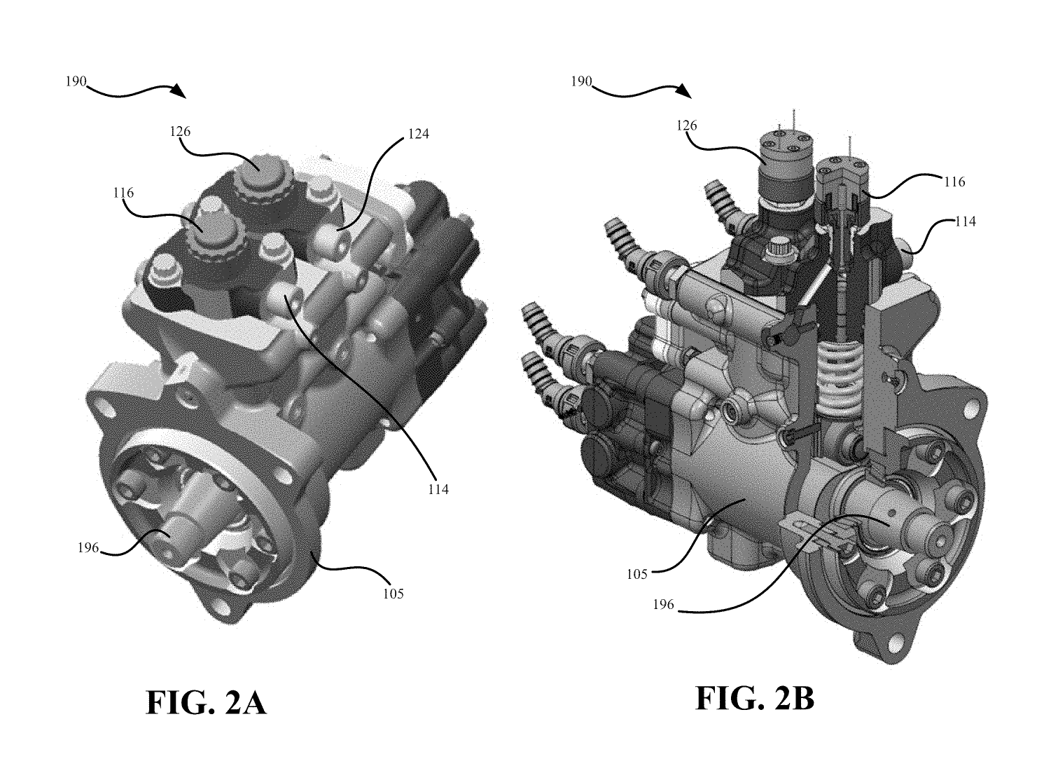

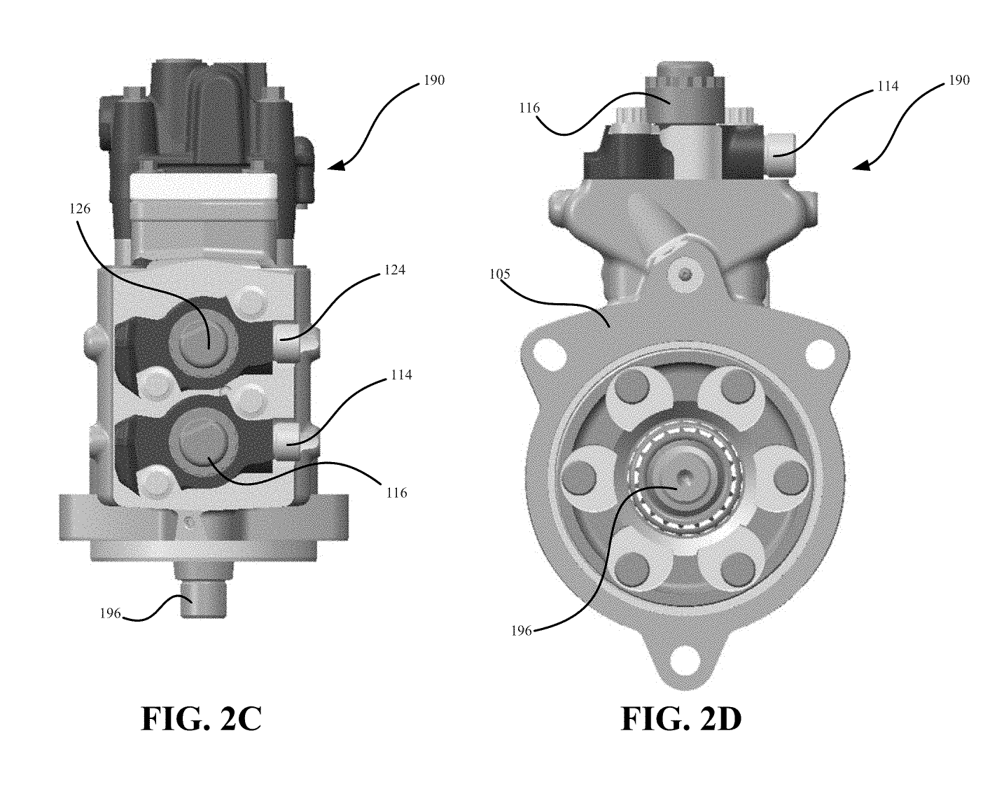

FIG. 1 is a diagram of a fueling system according to various embodiments. Fueling system 100 may include fuel distribution system 10 coupled to fuel pump 190. The exemplary embodiment shown in FIGS. 1 and 2A-D exemplifies fuel pump 190 with two cylinders or plungers, first plunger 191 and second plunger 192. First plunger 191 and second plunger 192 may be operatively connected with first cam lobe 193 and second cam lobe 194. Cam lobes 193, 194 may be operatively coupled with cam shaft 196 that may rotate around cam shaft axis 50. As cam shaft 196 rotates around cam shaft axis 50, first cam lobe 193 and second cam lobe 194 may respectively cause first plunger 191 and second plunger 192 to reciprocate and, thus pump fuel from first inlet valve 118 and second inlet valve 128 into first fuel circuit 111 and second fuel circuit 121, respectively.

Thus, the single fuel pump 190 in this example comprises a first plunger 191 operationally coupled to the first fuel rail 110 and a second plunger 192 operationally coupled to the second fuel rail 120.

In various embodiments, fueling system 100 may comprise a fuel pump 190 operationally coupled to a first inlet valve 118, a second inlet valve 128, a first outlet valve 114, and a second outlet valve 124. In various embodiments, a controller 150 may be in electrical communication with the first inlet valve 118, the second inlet valve 128, a first inlet valve actuator 116, a second inlet valve actuator 126, a first fuel rail 110, and a second fuel rail 120.

In certain embodiments, the controller 150 may include one or more interpreters, determiners, evaluators, regulators, and/or processors, that functionally execute the operations of the controller 150. The description herein including interpreters, determiners, evaluators, regulators, and/or processors, emphasizes the structural independence of certain aspects of the controller 150, and illustrates one grouping of operations and responsibilities of the controller 150. Other groupings that execute similar overall operations are understood within the scope of the present application. Various interpreters, determiners, evaluators, regulators, and/or processors, may be implemented in hardware and/or as computer instructions on a non-transient computer readable storage medium, and may be distributed across various hardware or computer based components.

Example and non-limiting implementation elements that functionally execute the operations of the controller 150 include sensors providing any value determined herein, sensors providing any value that is a precursor to a value determined herein, datalink and/or network hardware including communication chips, oscillating crystals, communication links, cables, twisted pair wiring, coaxial wiring, shielded wiring, transmitters, receivers, and/or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), and/or digital control elements.

In one embodiment, controller 150 may be a known control unit customarily referred to by those of ordinary skill as an electronic or engine control module (ECM), electronic or engine control unit (ECU) or the like, or may alternatively be a control circuit capable of operation as will be described herein

Controller 150 may be configured to receive a first pressure reading from the first fuel rail 110 and a second pressure reading from the second fuel rail 120. For example, FIG. 1 illustrates controller 150 in electrical communication with first pressure sensor 112 and second pressure sensor 122, which may be operatively coupled with first fuel rail 110 and second fuel rail 120, respectively.

Thus, in various embodiments, the first fuel rail 110 may be operationally coupled to the first inlet 118 along a first fuel circuit 111. Similarly, the second fuel rail 120 may be operationally coupled to the second inlet 128 along a second fuel circuit 121. In various embodiments, the first circuit 111 may be independent of the second circuit 121, as exemplified in FIG. 1.

Moreover, in various embodiments, the first fuel rail 110 and the second fuel rail 120 may be operationally coupled to the fuel pump 190 in parallel, as exemplified in FIG. 1.

Various fueling systems may also comprise a single fuel pump 190 configured to supply fuel to a first fuel rail 110 at a first fuel pressure along a first fuel circuit 111 and configured to supply fuel to a second fuel rail 120 at a second fuel pressure along a second fuel circuit 121, wherein the first fuel rail 110 and second fuel rail 120 are arranged in parallel, and the first fuel circuit 111 is independent of the second fuel circuit 121.

In various embodiments, the first inlet valve 118 may be operationally coupled to the first fuel rail 110 and the single fuel pump 190 and a second inlet valve 128 may be operationally coupled to the second fuel rail 120 and the single fuel pump 190. The number of inlet valves are not particularly limited and, thus, various fueling systems may comprise additional inlet valves. For example, some fueling systems may comprise a third inlet valve (not shown) operationally coupled to a single fuel pump.

Controller 150 may also be configured to adjust the first inlet valve 118 based, in part, on the first pressure reading and adjust the second inlet valve 128 based, in part, on the second pressure reading.

For example, controller 150 may be operatively coupled with first inlet valve actuator 116 and second inlet valve actuator 126 to affect first inlet valve 118 and second inlet valve 128, respectively. In various embodiments, this may allow controller 150 to maintain the first fuel rail pressure at a different pressure than the second fuel rail pressure. Moreover, in various embodiments, controller 150 may also alternate the comparative relationship between the pressures of the first fuel rail 110 and the second fuel rail 120. Thus, the controller 150 may allow for two separate fuel pressures in two different rails that are supplied by a fuel pump, such as fuel pump 190.

Fuel pump 190 is not particularly limited and may comprise a first piston 191 and a second piston 192 contained within fuel pump housing 195 as shown in FIGS. 1 and 2B, wherein the first piston 191 is operationally coupled to the first fuel rail 191 and the second piston 192 is operationally coupled to the second fuel rail 120. In some embodiments, the fuel pump 190 may be configured to provide fuel to each fuel rail from a distinct and separate piston. For example, a fueling system having four rails may be supplied fuel from a single fuel pump having four pistons, with each piston supplying fuel to a separate fuel rail. In various embodiments, each fuel rail may be arranged in parallel (e.g., with its own distinct fuel circuit). For example, FIG. 1 illustrates a fueling system 100 where the first fuel rail 110 and the second fuel rail 120 are operationally coupled to the fuel pump 190 in parallel. In various embodiments, fuel pump 190 may be a high pressure fuel pump.

First fuel rail 110 and second fuel rail 120 may be configured to supply fuel to the injectors of an engine (not shown). Thus, engines comprising the fuel systems disclosed herein are also disclosed. The particular engine is not limited and may be a diesel engine, a gasoline engine, or a hybrid engine.

In various embodiments, the first fuel rail 110 may be operationally coupled to a first fuel injector (not shown), the second fuel rail 120 may be operationally coupled to a second fuel injector (not shown), and the first fuel injector and the second fuel injector supply fuel to at least one cylinder of the engine. Thus, in various embodiments, the at least one cylinder may be the same cylinder or, in other embodiments, may be different cylinders. Accordingly, when the at least one cylinder is the same cylinder, the first fuel injector and the second fuel injector may both provide fuel to the same cylinder during an injector event(s), furthering the efficiency of the engine while reducing emissions.

Moreover, in various embodiments, the first fuel rail 110 and the second fuel rail 120 may be operationally coupled to the same fuel injector, such as a rate shaping fuel injector. Thus, in various embodiments, two fuel rails having different rail pressures, may supply fuel to the same injector. In various embodiments, engines may comprise various control valves and/or control modules, such as controller 150, to switch between the rail that provide different injection pressures to one or more sets of spray holes. Furthermore, the first fuel rail 110 and the second fuel rail 120 may both be coupled to a first fuel injector and/or a second fuel injector.

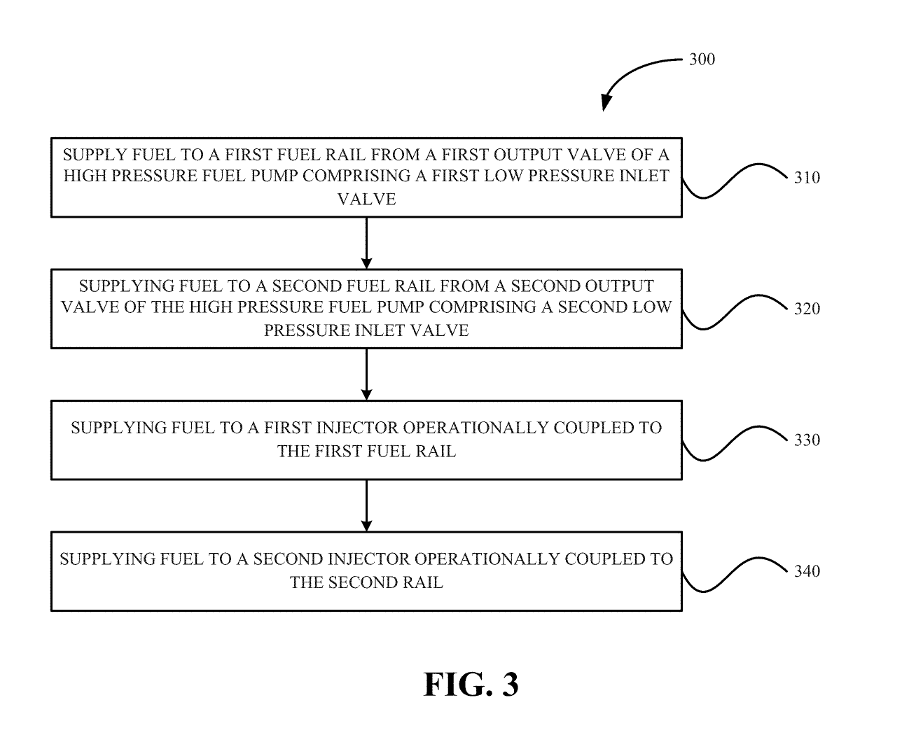

FIG. 3 illustrates method 300 of supplying fuel to an engine. Method 300 may comprise supplying fuel to a first fuel rail 110 from a first output valve 116 of a fuel pump 190 operationally coupled to a first inlet valve 118 (step 310), supplying fuel to a second fuel rail 120 from a second output valve 126 of the fuel pump 190 operationally coupled to a second inlet valve 128, supplying fuel to a first injector operationally coupled to the first fuel rail 110, and supplying fuel to a second injector operationally coupled to the second fuel rail 120, wherein a first fuel rail pressure is different than a second fuel rail pressure.

The method may include the fueling systems disclosed herein, such as fueling system 100 that comprises controller 150. In various embodiments, method 300 may also include adjusting, by controller 150, the first inlet valve 111 based, in part, on a first pressure reading and adjusting, by the controller 150, the second inlet valve 121 based, in part, on a second pressure reading.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. §112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A fueling system comprising:
a fuel pump operationally coupled to a first inlet valve, a second inlet valve, a first outlet valve, and a second outlet valve; and
a controller in electrical communication with the first inlet valve, the second inlet, a first fuel rail operationally coupled to the first inlet valve, and a second fuel rail operationally coupled to the second inlet valve;
wherein the controller is configured to receive a first pressure reading indicating a fuel pressure in the first fuel rail and a second pressure reading indicating a fuel pressure in the second fuel rail, and
the controller is configured to adjust the first inlet valve in response to the first pressure reading to supply a first fuel rail pressure to the first fuel rail and to adjust the second inlet valve in response to the second pressure reading to supply a second fuel rail pressure to the second fuel rail,
the first fuel rail pressure being different than the second fuel rail pressure.

2. The fueling system of claim 1, wherein the first fuel rail is operationally coupled to the first inlet valve along a first fuel circuit, the second fuel rail is operationally coupled to the second inlet valve along a second fuel circuit, and the first circuit is independent of the second circuit.

3. The fueling system of claim 1, wherein the first fuel rail and the second fuel rail are operationally coupled to the fuel pump in parallel.

4. The fueling system of claim 1, wherein
the fuel pump comprises a first piston and a second piston,
the first piston is operationally coupled to the first fuel rail, and
the second piston is operationally coupled to the second fuel rail.

5. The fueling system of claim 4, wherein the first fuel rail and the second fuel rail are operationally coupled to the fuel pump in parallel.

6. A system comprising an engine operationally coupled to the fueling system of claim 1.

7. The system of claim 6, wherein the engine is a diesel engine.

8. The system of claim 6, wherein the first fuel rail is operationally coupled to a first fuel injector,
the second fuel rail is operationally coupled to a second fuel injector, and
the first fuel injector and the second fuel injector supply fuel to at least one cylinder of the engine.

9. The system of claim 8, wherein the at least one cylinder is the same cylinder.

10. The system of claim 6, wherein the first fuel rail and the second fuel rail are both operationally coupled to a first fuel injector.

11. The system of claim 10, wherein the first fuel rail and the second fuel rail are both operationally coupled to a second fuel injector.

12. A fueling system comprising:
a single fuel pump configured to supply fuel at a first pressure to a first fuel rail along a first fuel circuit and configured to supply fuel at a second pressure to a second fuel rail along a second fuel circuit,
wherein the first fuel rail and second fuel rail are arranged in parallel, and the first fuel circuit is independent of the second fuel circuit.

13. The fueling system of claim 12, further comprising a first inlet valve operationally coupled to the first fuel rail and the single fuel pump and a second inlet valve operationally coupled to the second fuel rail and the single fuel pump.

14. The fueling system of claim 13, further comprising a third inlet valve operationally coupled to the single fuel pump.

15. The fueling system of claim 12, further comprising a controller configured to receive a first pressure reading from the first fuel rail and a second pressure reading from the second fuel rail.

16. The fueling system of claim 12, wherein the single fuel pump comprises a first piston and a second piston, wherein the first piston is operationally coupled to the first fuel rail and the second piston is operationally coupled to the second fuel rail.

17. A system comprising an engine operationally coupled to the fueling system of claim 12.

18. The system of claim 17, wherein the engine is a diesel engine.

19. The system of claim 17, wherein the first fuel rail is operationally coupled to a first fuel injector, the second fuel rail is operationally coupled to a second fuel injector, and the first fuel injector and the second fuel injector supply fuel to at least one cylinder of the engine.

20. The system of claim 19, wherein the at least one cylinder is the same cylinder.

21. A method of supplying fuel to an engine comprising:
supplying fuel to a first fuel rail from a first output valve operationally coupled to a fuel pump operationally coupled to a first inlet valve;
supplying fuel to a second fuel rail from a second output valve of the fuel pump operationally coupled to a second inlet valve;
supplying fuel to a first injector operationally coupled to the first fuel rail; and
supplying fuel to a second injector operationally coupled to the second fuel rail, wherein a first fuel rail pressure is different than a second fuel rail pressure.

22. The method of claim 21, further comprising:
adjusting, by a controller, the first inlet valve based, in part, on a first pressure reading indicating a fuel pressure in the first fuel rail; and
adjusting, by the controller, the second inlet valve based, in part, on a second pressure reading indicating a fuel pressure in the second fuel rail.
